(19) United States
(12) Patent Application Publication
(10) Pub. No.: US 2019/0108535 A1
(43) Pub. Date: Apr. 11, 2019

(54) SELF-REVIEW SYSTEMS AND METHODS

(71) Applicant: Netsolace, Inc., Wallingford, CT (US)

(72) Inventors: Tariq FARID, Cheshire, CT (US); Somia FARID, New Haven, CT (US); Cheikh MBOUP, Jacksonville, FL (US)

(73) Assignee: Netsolace, Inc., Wallingford, CT (US)

(21) Appl. No.: 15/725,743

(22) Filed: Oct. 5, 2017

(51) Int. Cl. G06Q 30/02; G06F 17/30; H04L 29/06

(52) U.S. Cl. CPC G06Q 30/0203; H04L 63/083; G06F 17/30268; G06Q 30/0282

(57) ABSTRACT

A franchise site may be audited with a user device. A location module of the user device may generate location data for the user device. A processor circuit of the user device may determine from the location data whether the user device is at the franchise site or a different location. A camera module of the user device may generate image data. The processor circuit may compare the image data with known image data for a specified portion of the franchise site to determine whether the image data includes an image of the specified portion of the franchise site or a different image.

### FIELD

The present disclosure generally relates to inspection and audit of franchisees. Specifically, the present disclosure relates to a self-review system and method for franchisees and franchisors.

### BACKGROUND

Physical locations, such as business locations held by franchisees, may be inspected or audited. For example, field teams may conduct audits (also called quality assurance reviews) at franchise locations on a recurring basis that may be determined by the franchisor.

However, the challenges that come with having a team that focuses just on quality assurance at the store level include not having enough staff to visit the stores and little to no visibility of what is happening at the franchise locations on a daily basis.

### SUMMARY

The present disclosure relates to a method of auditing a franchise site with a user device. The method can comprise generating location data for the user device by a location module of the user device. A processor circuit of the user device in communication with the location module can determine from the location data whether the user device is at the franchise site or a different location. The method can also comprise generating image data by a camera module of the user device in communication with the processor circuit. The processor circuit can compare the image data with known image data for a specified portion of the franchise site to determine whether the image data includes an image of the specified portion of the franchise site or a different image. If the processor circuit determines that the user device is at the franchise site and the image data includes the image of the specified portion of the franchise site, a communication module of the user device in communication with the processor circuit can send at least a portion of the location data, at least a portion of the image data, or a combination thereof to a server.

In some embodiments, the location module can comprise a GPS transponder, a cellular transponder, a Wi-Fi transponder, or a combination thereof. In some embodiments, the method can comprise sending the location data to the server and receiving a location comparison result from the server by the location module.

In some embodiments, the method can comprise adding a label to the image data. The label can comprise a time stamp, a location stamp, an IP address, a user's name, an electronic signature, or a combination thereof. In some embodiments, the image data can comprise at least one still image, at least one video, or a combination thereof.

In some embodiments, if the processor circuit determines that the user device is at the different location or the image data includes the different image, the processor circuit can generate an error message. In some embodiments, if the processor circuit determines that the user device is at the different location or the image data includes the different image, the processor circuit can reject the image data.

In some embodiments, the method can comprise receiving a personal identification number (PIN) to verify an identity of a user.

In some embodiments, the method can comprise presenting at least one question on a display of the user device in communication with the processor circuit, and receiving at least one answer to the at least one question by an input device of the user device in communication with the processor circuit. The method can further comprise sending the at least one answer to the server by the communication module if it is determined that the user device is at the franchise site and the image data includes the image of the specified portion of the franchise site.

The present disclosure also relates to a user device configured to audit a franchise site. The user device can comprise a location module configured to generate location data for the user device, a camera module configured to generate image data, a communication module, and a processor circuit in communication with the location module, the camera module, and the location module. The processor circuit is configured to determine from the location data whether the user device is at the franchise site or a different location and compare the image data with known image data for a specified portion of the franchise site to determine whether the image data includes an image of the specified portion of the franchise site or a different image. If it is determined that the user device is at the franchise site and the image data includes the image of the specified portion of the franchise site, the communication module can send the at least a portion of the location data, at least a portion of the image data, or a combination thereof to a server.

In some embodiments, the location module can comprise a GPS transponder, a cellular transponder, a Wi-Fi transponder, or a combination thereof. In some embodiments, the communication module can send the location data to the server and receive a location comparison result from the server.

In some embodiments, the processor circuit can add a label to the image data. The label can comprise a time stamp, a location stamp, an IP address, a user's name, an electronic signature, or a combination thereof. The image data can comprise at least one still image, at least one video, or a combination thereof.

In some embodiments, if it is determined that the user device is at the different location or the image data includes the different image, the processor circuit can send an error message. In some embodiments, if it is determined that the user device is at the different location or the image data includes the different image, the processor circuit can reject the image data.

In some embodiments, the processor circuit can receive a personal identification number (PIN) to verify an identity of a user.

In some embodiments the user device can further comprise a display and an input device. The processor circuit can present at least one question on the display. The input device can receive at least one answer to the at least one question. If it is determined that the user device is at the franchise site and the image data includes the image of the specified portion of the franchise site, the communication module can send the at least one answer to the server.

### BRIEF DESCRIPTION OF THE DRAWINGS

FIG. 1 is a block diagram of a self-review system according to some embodiments of the disclosure.

FIG. 2 is a self-review process according to some embodiments of the disclosure.

FIG. 3 is a location verification process according to some embodiments of the disclosure.

FIG. 4 is a self-review process according to some embodiments of the disclosure.

FIG. 5 shows a media attachment process according to some embodiments of the disclosure.

FIG. 6 is a follow-up request process according to some embodiments of the disclosure.

FIGS. 7A-7C is an administrative process according to some embodiments of the disclosure.

FIGS. 8A-8B is a template creation process according to some embodiments of the disclosure.

FIG. 9 is a review settings process according to some embodiments of the disclosure.

FIG. 10 is a block diagram of an example mobile device configured to implement the features and processes of FIGS. 1-9.

FIG. 11 is a block diagram of an example server configured to implement the features and processes of FIGS. 1-9.

### DETAILED DESCRIPTION

To audit franchise sites, operation teams may create reviews that may get pushed out to the field teams. When field teams are in franchise locations conducting reviews, they may attach pictures, add follow-ups, and mark items as critical failures. At the end of each review, the franchise location may get a score. When the operations team creates a review, they may have the option to enable scoring. If scoring is enabled, each question may be assigned a percentage. A backend system may use the scores for each question to calculate an average score for the review.

Systems and methods described herein may allow staff at franchise locations to conduct their own reviews without the involvement of field teams, reducing or eliminating the need for field teams while providing more consistent and frequent visibility into franchise location operations. Users may utilize desktop, mobile, tablet, and/or other devices to do their own brand standard reviews on a recurring basis determined by the franchisor. Not only may this reduce challenges on the franchisor-end, it may also incentivize and encourage franchisees to keep their locations up to brand standards and expectations. The corporate team may dictate and manage content for the reviews.

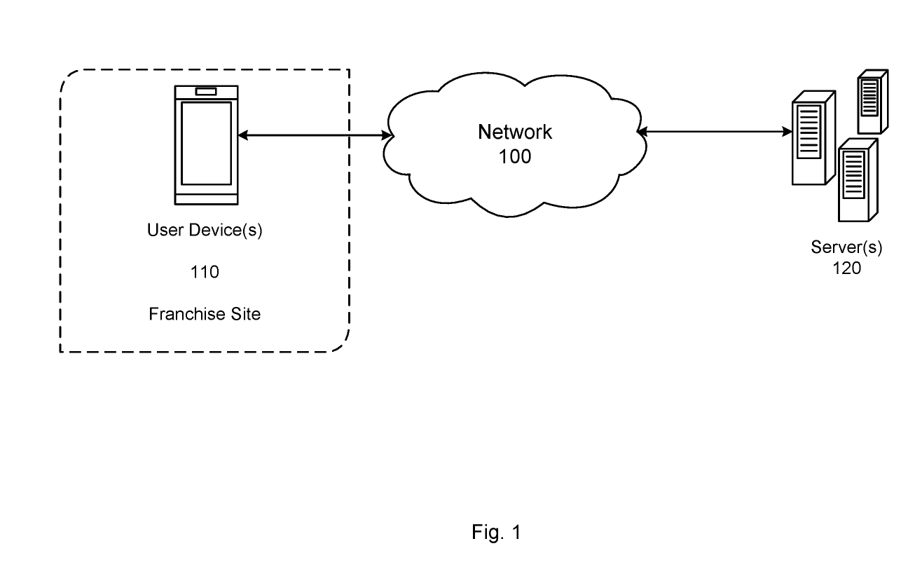

FIG. 1 is a block diagram according to some embodiments of the disclosure. Franchisors and franchisees may cooperate to perform audits of franchise sites using the network of FIG. 1. For example, franchisees may operate one or more user devices 110 at a franchise site. Franchisors may operate one or more servers 120. User devices 110 and servers 120 may communicate with one another using network 100, for example the Internet, a private corporate network, or some other network. In some embodiments, a franchisor may use server 120 to publish a review that must be completed by the franchise owner or manager within a specific time frame. The franchise location may be required to complete the review before the due date. The franchisor may specify repercussions for franchisees who do not complete their reviews by the due date. A user at the franchise site may use user device 110 to complete the review. Once the review is completed by the location, the corporate team on the franchisor side may be notified and may approve the review (or deny and add follow-ups if necessary) using server 120 and/or a user computer in communication with server 120 (not shown). While the example embodiments presented herein involve a franchisee conducting a self-review for approval by a franchisor, the systems and methods may be applied to any arrangement requiring auditing of remote locations.

### Self-Review

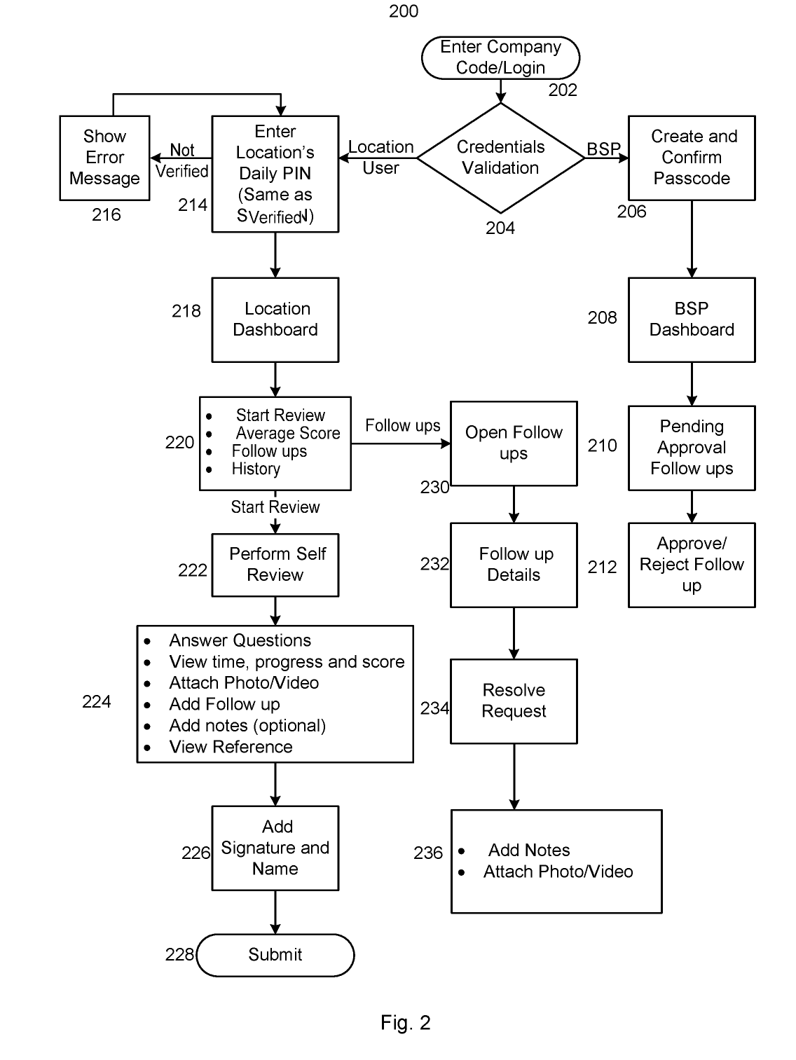

FIG. 2 is a self-review process 200 according to some embodiments of the disclosure. Process 200 may be performed by user device 110, which may accept user inputs at the franchise site and communicate remotely with server 120. Process 200 may allow franchisees to perform self-reviews and follow up on previously performed reviews, for example.

At step 202, user device 110 may receive a company code and/or user login information from a user. For example, a user may launch a self-reporting app and may enter a company code specifying the franchisor company and login information identifying the user and/or the franchise location. At step 204, user device 110 may validate the entered information and allow the user to log in if the entered information is valid.

User device 110 may provide different interfaces for different users in some embodiments. One example user may be a brand standards partner (BSP), such as a franchisor's field employee visiting a franchise location. At step 206, user device 110 may perform processing associated with allowing the BSP to create a unique passcode, such as a 4-digit PIN, that they may use to log into the app every time they open it. The PIN can be used in conjunction with or instead of an email and password for log in.

The BSP may track her time in the field using user device 110. At step 208, once the BSP logs into the app, user device 110 may display a dashboard. The dashboard may display at least two buttons—CLOCK IN and CLOCK OUT. Once the BSP hits the clock in button indicating she have started her day to allow the franchisor to track her time, both buttons may change and say CHECK IN and CHECK OUT. The BSP may hit the CHECK IN button when she steps into the location. Once they leave the location, she may check out. This allows corporate to track how long she is at each location. Once she has checked out of the location, the button may change back to CLOCK OUT. Each time a BSP presses one of the buttons, user device 110 may receive and log the input. User device 110 may generate data such as a log describing the BSP's activity and send the data to server 120.

The dashboard screen may include links to other pages in the app such as, for example—NEARBY LOCATIONS, DUE REVIEWS, OVERDUE REVIEWS, MY WEEKLY SCHEDULE, FOLLOW UPS, REVIEW HISTORY, COMMUNICATIONS. The dashboard may display the BSP's stats for a particular time period (e.g., the current week). The stats may include completed reviews, reviews required for the week, rate per week, and average time at store, for example. User device 110 may generate the stats from the log data, for example.

In some embodiments, the BSP may be able to approve or reject incomplete items from previous reviews by using user device 110. At step 210, user device 110 may present information about reviews that have items that are pending approval. For example, a review may include a question that asks “is the van up to date with service and running properly?” but the van's check engine light is on. The BSP may answer the question no and add a follow up that this issue must be solved in a certain number of days. Once the franchisee has confirmed that they have fixed the issue and provided proof to server 120, the follow up may be added to the “pending approval” bucket. User device 110 may receive information about pending review items from server 120 and present the information to the BSP. At step 212, user device 110 may receive BSP input regarding whether the pending approval items have been approved or rejected. Items may be required to be approved by the BSP in order to be solved. Server 120 and franchisee's user device 110 may notify the franchisee of any rejected items so that the rejected items may be corrected.

In addition to BSPs, franchisees may use the app on user device 110. Franchisors may have the option to enable a feature that requires all locations to enter a unique PIN code when opening the app. Each location may have a unique PIN that changes periodically, for example on a daily basis. At step 214, user device 110 may display an interface requiring the user to enter a PIN. The user may enter the PIN, and user device 110 may verify the PIN. For example, user device 110 may send the PIN to server 120, and server 120 may report back to user device 110 with an indication of whether the PIN is correct. Alternatively, user device 110 may receive the correct PIN information from server 120 prior to the user entering the PIN and check the PIN itself. At step 216, if the PIN is incorrect, user device 110 may display an error message. User may be able to retry PIN entry after acknowledging the error message.

Once user device 110 has verified the PIN, at step 218, user device 110 may display a location dashboard. When the user begins a review, user device 110 may require the user to verify that they are at the location. The user may use the location dashboard to enter her location, for example by selecting or inputting a specific franchise location. This may be referenced using user device 110 location services such as GPS, cellular, and/or Wi-Fi location features. If the user is completing the review somewhere other than the location, this fact may be flagged so that corporate is aware. In some embodiments, the location's coordinates may be matched with the detected location of user device 110 as another layer of verification.

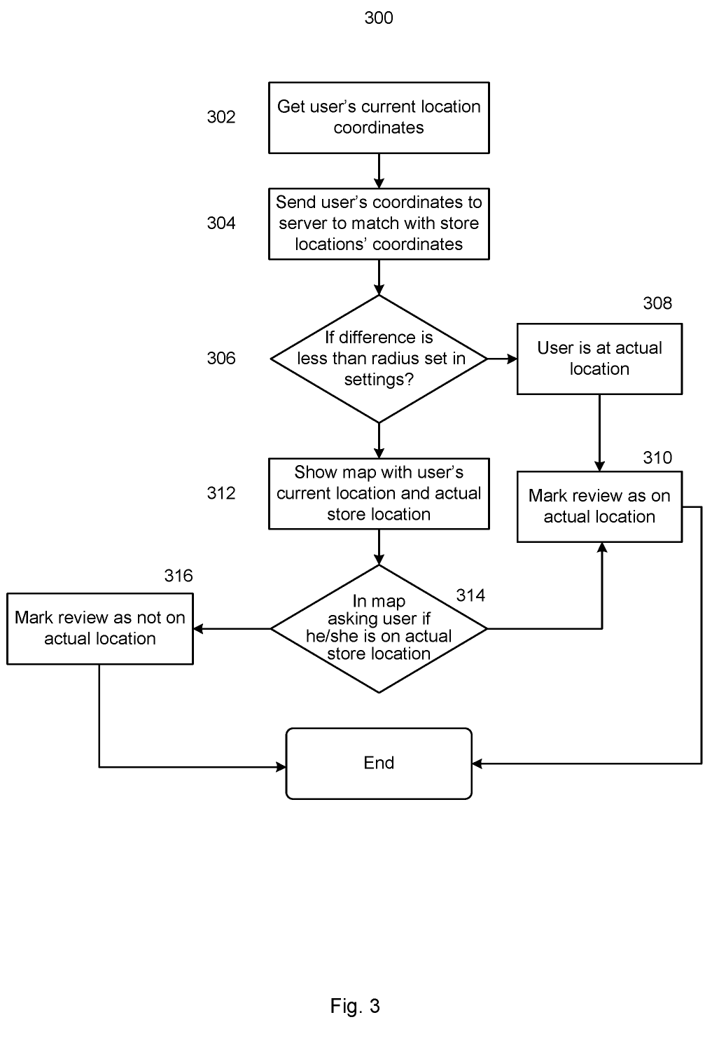

FIG. 3 is a location verification process 300 according to some embodiments of the disclosure. User device 110 may perform process 300 to verify a user location entered by the user in 218 of process 200, for example.

At step 302, user device 110 may get its current location coordinates. For example, an iOS® device such as an Apple® iPhone® may use Apple® map service and user device 110 GPS receiver to determine its coordinates. An Android™ device may use Google Maps™ mapping service and user device 110 GPS receiver to determine its coordinates. Other devices may use other built-in device location features to determine location coordinates.

At step 304, user device 110 may send the device coordinates to server 120, and server 120 may determine whether user device 110 is at the expected franchise location by matching the device coordinates with coordinates for the franchise location stored by server 120. At step 306, server 120 may determine whether user device 110 is within a predefined acceptable radius of the franchise location based on the device coordinates.

If user device 110 is within the predefined radius, at step 308, server 120 may determine the user is at the correct location. At step 310, server 120 may store data indicating the review is being conducted at the correct location. If user device 110 is not within the predefined radius, at step 312, server 120 may notify user device 110. User device 110 may display a map with the user's current location and the franchise location. At step 314, user device 110 may prompt the user to confirm she is at the franchise location despite the map discrepancy. A user may indicate yes, for example, if she is close to the location but there is an error in location or she is just outside the radius. A user may indicate no, for example, if she is in the incorrect location due to user error or the like. If the user indicates yes, user device 110 may inform server 120, and at step 310, server 120 may store data indicating the review is being conducted at the correct location. If the user indicates no, user device 110 may inform server 120, and, at step 318, server 120 may store data indicating the review is not being conducted at the correct location.

Returning to process 200, once the location has been verified, user device 110 may display options that may be selectable by the user. Options may include starting a self-review, viewing average score data (e.g., for the franchise and/or across multiple franchises), following up with past reviews, viewing historical data, and/or others. At step 220, user device 110 may receive user selection of an option on the dashboard. For example, a user may opt to start a review. At step 222, user device 110 may perform the self-review process.

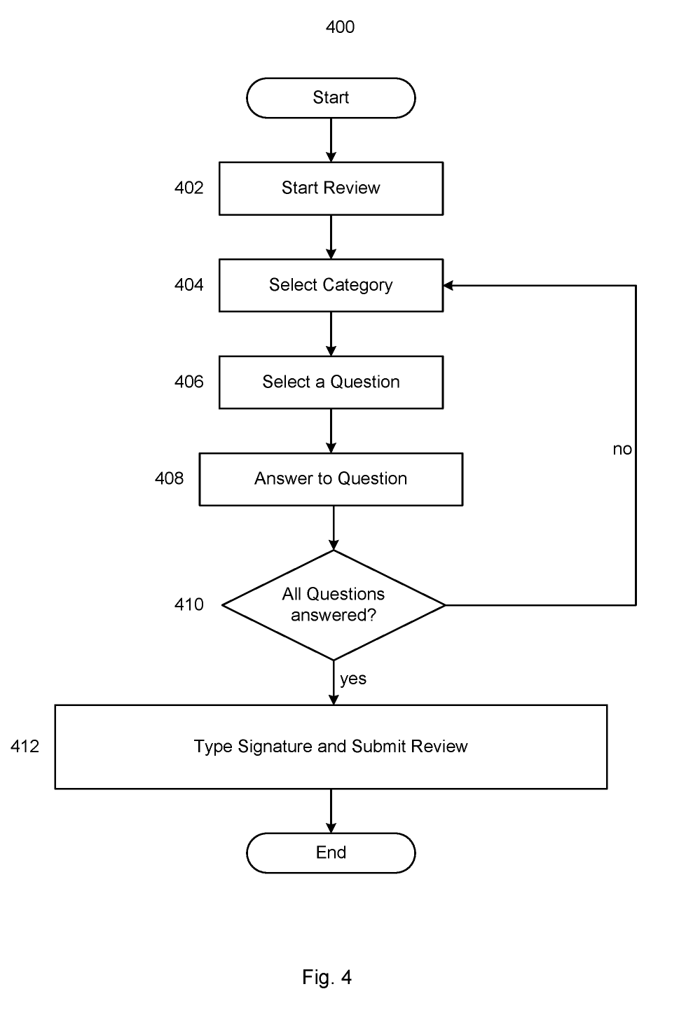

FIG. 4 is a self-review process 400 according to some embodiments of the disclosure. In 402, in response to a user input requesting a self-review, user device 110 may start the self-review process 400. The self-review process 400 may include gathering answers to questions and/or other information from the user and submitting the answers and/or other information to server 120.

Throughout the self-review process 400, user device 110 may display information to the user. User device 110 may display a timer which shows time spent while performing a review. When the user submits the review, user device 110 may submit total time taken by the user to conduct the review to server 120 along with other information, and this information may be visible with the review on corporate and owner end websites, for example. While performing a review, if the app goes into the background of user device 110, the time may stop, and that time will not be included in total time spent.

User device 110 may display a progress indicator and score. The progress indicator may show how many questions the user has performed/answered. Progress may only include mandatory/required questions in some embodiments. In some embodiments, a “score” feature may be added to the review process. This may be realized by checking a corresponding “Scoring” box when a review is created. In some embodiments, different scores may be assigned to different answers to a question by the corporate while creating the question. In some embodiments, different questions may have different assigned weights. At the end of the self-review process 400, a weighted average score may be calculated. For example, if there are five questions in total and the first question is relatively important, the first question might be worth 60% in the weighted average score and the other four questions might be worth 10% each. A passing score may be set when the review is created, for evaluation purposes.

User device 110 may start the review by providing question categories for the user to select. At step 404, user device 110 may receive user selection of a question category. In response, user device 110 may display one or more questions pertaining to the selected category. At step 406, user device 110 may receive user selection of a question and, at step 408, user device 110 may receive an answer to the selected question from the user. In some embodiments, if reference(s) are associated with a question, user device 110 may display a “View Reference” button. On receiving user selection of this button, user device 110 may show reference detail. In some embodiments, the user may be able to add notes with the answer to the question. In this case, user device 110 may receive user notes along with the answer to the question at step 408. One or more additional actions may be associated with answering questions in some embodiments, such as adding photos and adding follow-ups. These features are described in greater detail below.

At step 410, user device 110 may determine whether all questions have been answered. If not, user device 110 may allow user to select another category and/or question and enter another answer. This may be repeated until all questions are answered. If all questions have been answered, at step 412, user device 110 may receive the user's signature and submit the review to server 120.

In some embodiments, self-review process 400 may include an education component. In addition to displaying questions and receiving answers, user device 110 may provide educational information to the user. For example, if there is a question that asks “is there a soap dispenser next to the sink?” it may be accompanied by a pop-up that tells the user “did you know that you must wash your hands for 20 seconds for effectiveness?” Users may be required to acknowledge the minimum industry standards, may be educated on new research and findings, and may be alerted in the event of recalls or emergency situations. User device 110 may store educational information in its own memory and/or may receive information pushed from server 120 (e.g., recall news or emergency information).

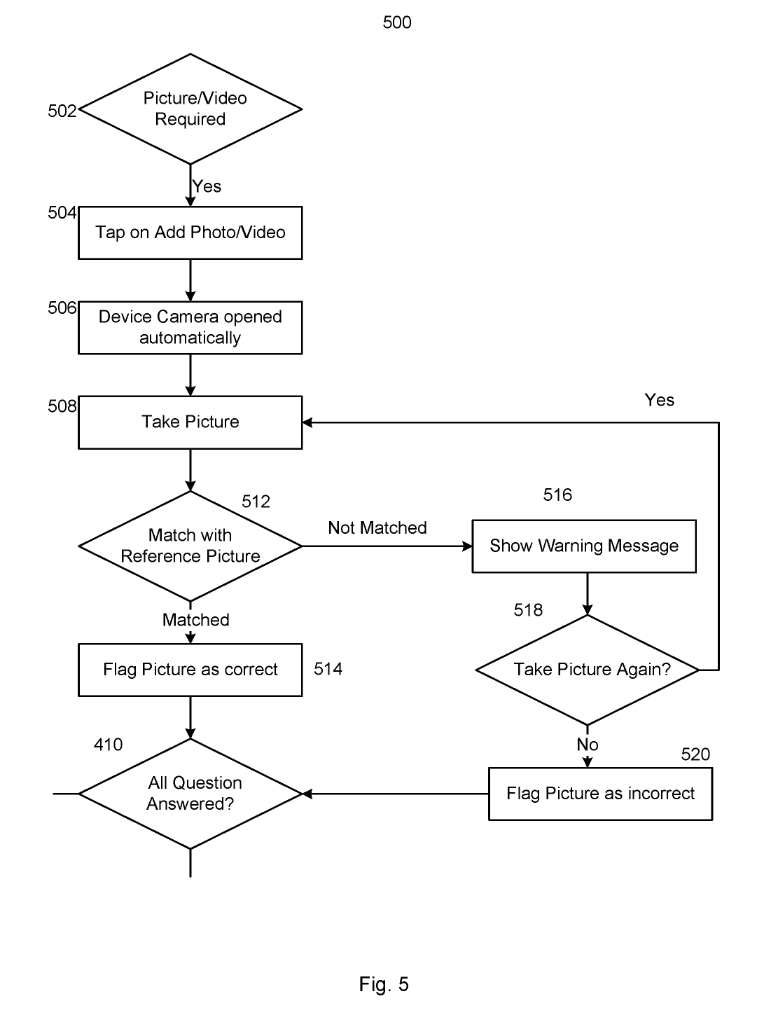

In some embodiments, a user may be able to add photos to answers to questions at step 408. FIG. 5 shows a media attachment process 500 according to some embodiments of the disclosure. Process 500 may require photos and/or videos attached to the review to be taken in real time. User device 110 may prevent the user from selecting a photo or video from user device 110 memory. This may ensure the uploaded media depicts the true state of the franchise location at the time, rather than an earlier photo or video showing better conditions, for example.

Turning to FIG. 5, at step 502, user device 110 may present a question requiring a photo and/or video and/or other media content to be attached. Not all questions may require media attachments in all embodiments. However, when media is required, user device 110 may prevent the user from advancing the self-review process 400 until media is attached. In some embodiments, some questions may allow optional addition of media.

At step 504, user device 110 may receive a user input instructing user device 110 to add a media attachment to the answer to the current question. At step 506, user device 110 may start the application enabling media capture, such as a camera app for capturing photos and/or videos. At step 508, user device 110 may record media and attach it to the answer. For example, user device 110 may capture one or more photos or videos and send them to server 120. In some embodiments, pictures and videos may be time stamped and may include some or all of the following information: date, time, location address, IP address, name of person who conducted the review, and/or other information. Specifically, after user device 110 records the media, user device 110 may add the time stamp and/or additional data to the media. The additional information may be collected from user device 110 systems such as clock (for date/time), location services (for location), network services (for IP address), name of logged in user from 202 (for user name), etc. In some embodiments wherein name of person who conducted the review is added, user device 110 may receive a typed user input of their name and may capture the user's e-signature to confirm that the review is being submitted after the question is answered or at the end of the self-review process 400. In the latter case, the user name may be added to the media before user device 110 sends the media to server 120, but not necessarily at the time of capture.

In some embodiments, an image-recognition algorithm can be used to evaluate the media added to an answer. Image recognition may make the self-review application highly automated by allowing user device 110 to flag photos/videos that do not match the standard photo provided by the franchisor. For example, if a user takes a photo of a dirty work station, user device 110 may automatically recognize that the photo looks different from a reference photo of the work station when it is clean. This may reduce the amount of time the franchisor spends going through the completed self-reviews. User device 110 may warn the user that something in their photo does not match the baseline photo submitted, and the user may have the opportunity to fix the issue. At step 512, after user device 110 records the media (and, in some embodiments, adds the additional data to the media), user device 110 may use image-recognition processing to compare the captured media with reference media. Questions that require media attachments may have associated reference media. User device 110 and/or server 120 may store a reference photo of a clean work station that is the subject of a question, for example. When user device 110 captures a new photo of the same work station, user device 110 may compare the new photo with the reference photo.

User device 110 may use the comparison to determine whether media is correct or not. For example, if the new image matches the reference image to a specified degree of similarity, at step 514, user device 110 may determine the picture is correct and move to determining whether all questions have been answered (see step 410 in FIG. 4). If the new image does not match the reference image to the specified degree of similarity, at step 516, user device 110 may display a warning message. For example, the images may not match when a user takes an image of the wrong location or when the location is correct but the image indicates that the appearance of the location is too different from the reference appearance to be acceptable (e.g., the location is dirty, broken, out of order, etc.). The warning message may notify the user that a new image is required. This may allow the user to go to the correct location or fix the problem with the location. Then, at step 518, user device 110 may receive user input indicating the user would like to take a new image of the location (presumably after the problem has been addressed). User device 110 may take a new picture (step 508) and repeat the comparison process (steps 512-516). If the user does not take another picture, at step 520, user device 110 may flag the picture as incorrect and move to determining whether all questions have been answered (see step 410 in FIG. 4).

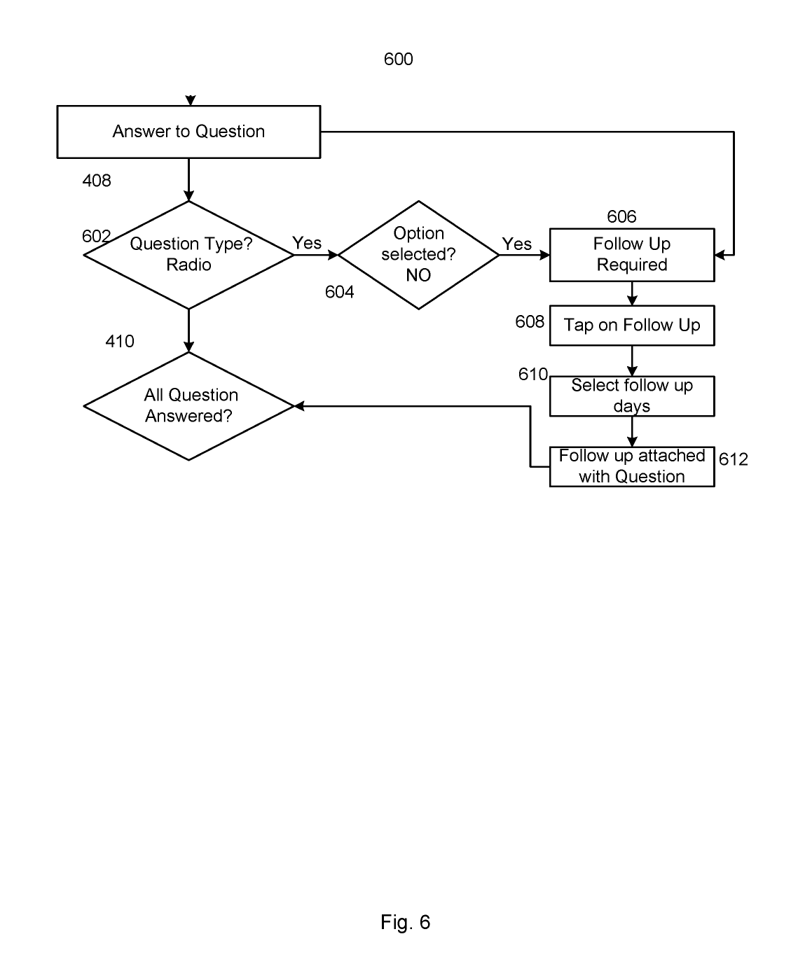

The user may be able to add follow-up requests when answering questions in some embodiments. FIG. 6 is a follow-up request process 600 according to some embodiments of the disclosure. Process 600 may be performed instead of or in addition to media attachment process 500 in some embodiments.

Follow up may be mandatory for yes/no questions when a user answers no. At step 602, user device 110 may determine whether the question is a yes/no question. If not, user device may move to determining whether all questions have been answered (see step 410 in FIG. 4). If the question is yes/no, at step 604, user device 110 may determine whether the user answered no. If not, user device may move to determining whether all questions have been answered (see 410 in FIG. 4). If the user answered no, at step 606, user device 110 may determine that follow up is required and indicate this to the user. At step 608, user device 110 may receive user instructions to request follow up. In 610, user device 110 may receive user instructions regarding when to schedule follow up (e.g., 1 day, 7 days, 15, days, 30 days, or other options). The user may also enter notes, which user device 110 may associate with the follow up schedule data. At step 612, user device 110 may attach the follow-up data (e.g., schedule data and notes data) to the question for reporting to server 120.

In some embodiments, user device 110 may provide an option to follow up with any question that is not a yes/no question. In this case, process 600 may begin at step 608 when a user requests follow up and proceed through steps 610 and 612 to 410, omitting steps 602-606.

Returning to FIG. 2, once all questions have been answered, at step 226, user device 110 may receive user name and signature data. For example, user device 110 may receive a typed user input of the user's name and may capture the user's e-signature to confirm that the review is being submitted at the end of the self-review process 200. Once the review is signed, at step 228, user device 110 may submit the review to server 120.

As noted above, users may generate follow ups during the self-review process 200. Users may also address previously created follow ups. At step 230, user device 110 may receive a user command to open a follow-ups interface. At step 232, user device 110 may display details about any follow ups that are pending. For example, follow-up details may indicate the question(s) for which follow up is required and any notes the user may have added. At step 234, user device 110 may receive user selection of a follow up to resolve. At step 236, user device may receive notes and/or media resolving the follow up. Media capture for follow ups may be performed as shown in media capture process 500 of FIG. 5. When the follow up has been addressed, user device 110 may send follow up information (e.g., the captured media and any added user notes) to server 120.

### Administration

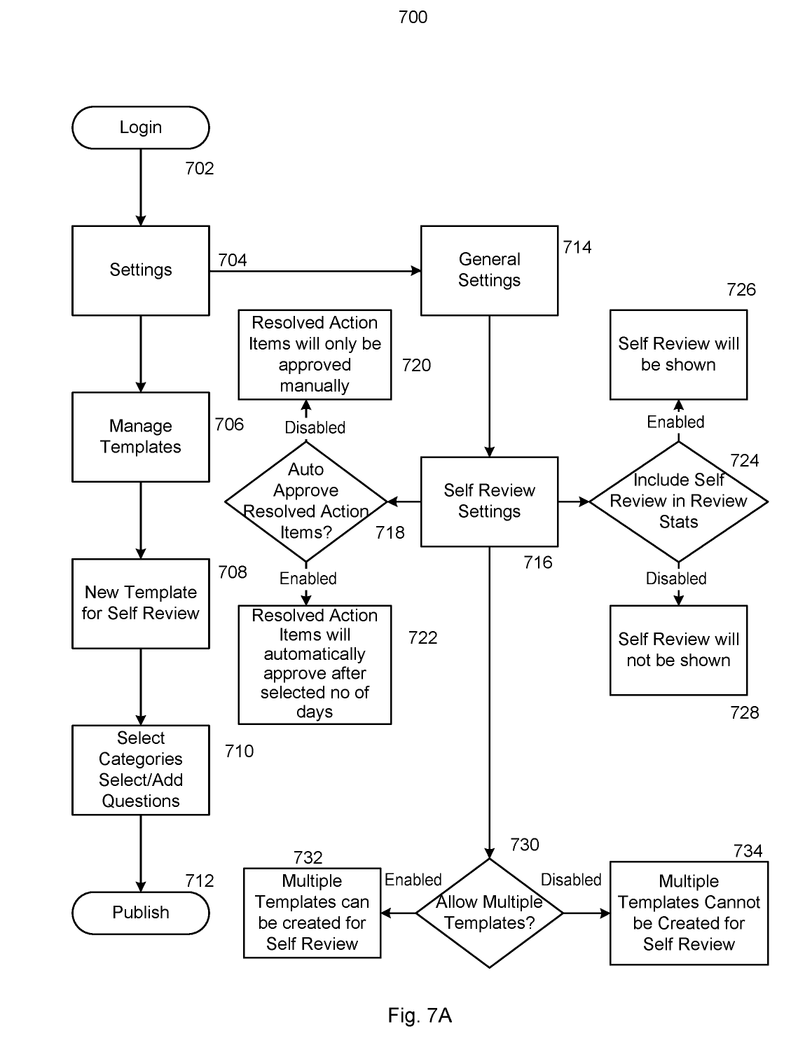

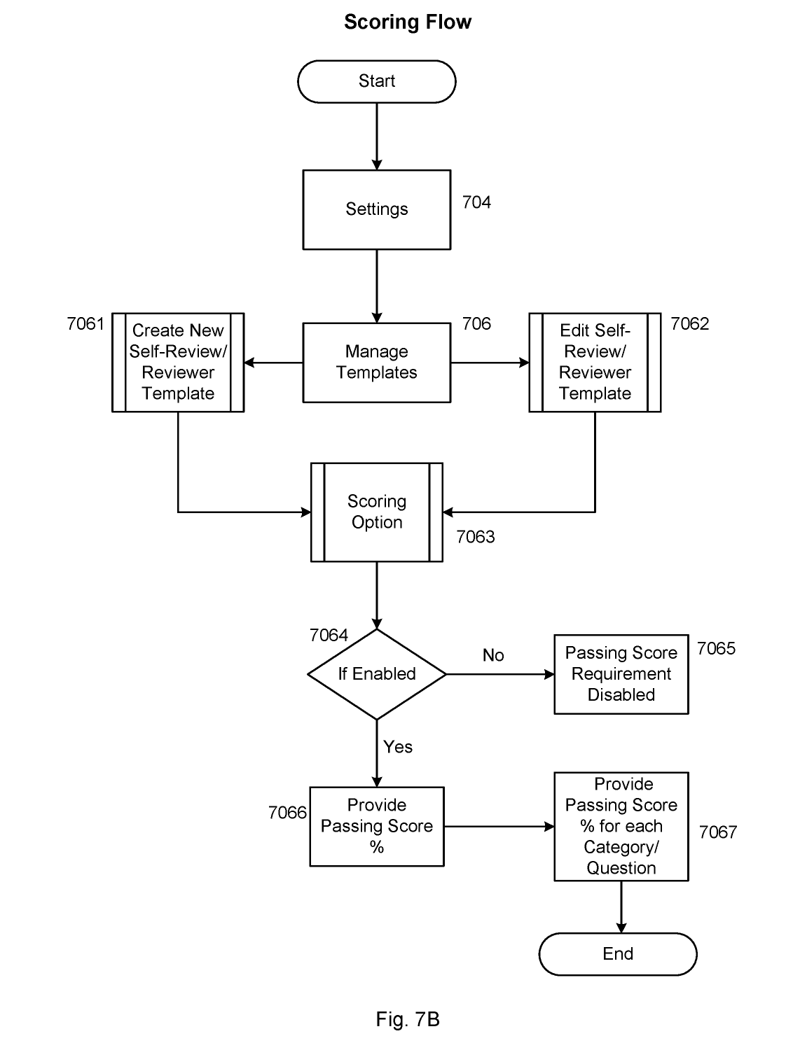

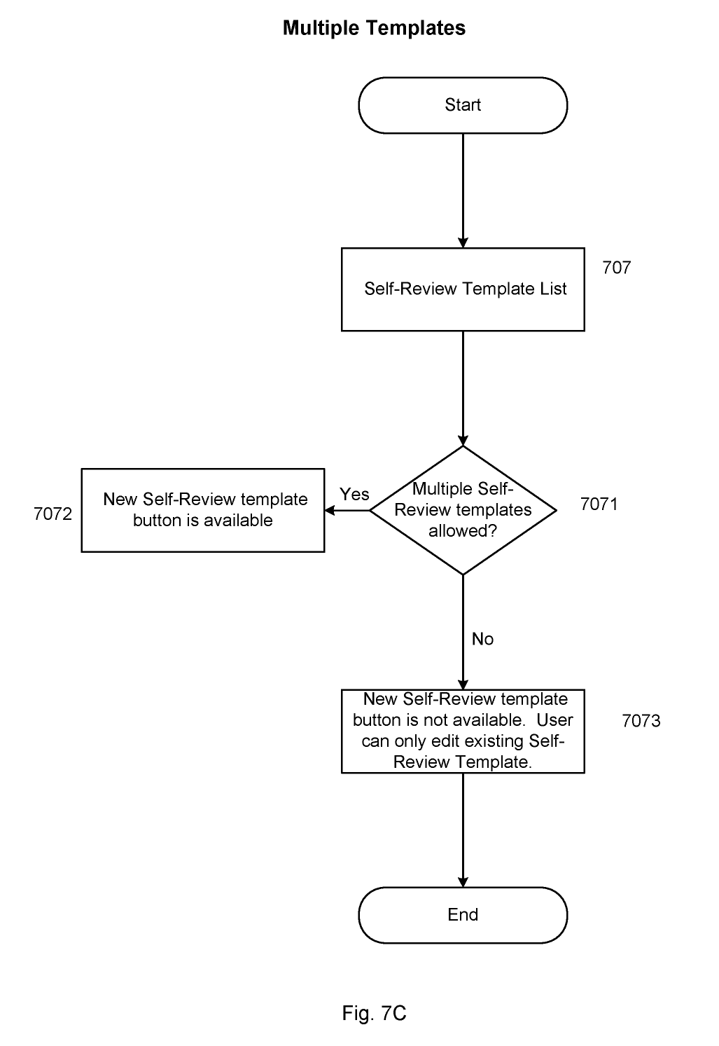

FIG. 7A is an admin process 700 according to some embodiments of the disclosure. Process 700 may be performed by server 120, which may accept user inputs from an administrator (e.g., a franchisor) and communicate remotely with user device 110. Process 700 may allow franchisors to establish self-review parameters, view self-reviews submitted by franchisees, and follow up on previously performed reviews, for example.

At step 702, server 120 may receive login information from a user. For example, a user may enter login information through a user interface provided by server 120 at server 120 or remotely, for example through a web interface.

At step 704, server 120 may display a settings interface. The settings interface may allow a user to adjust application-wide settings such as general settings, template management, reference information, user management, password settings, email template settings, etc. General settings and template management are discussed specifically in more detail below. The following examples illustrate other settings that may be adjusted using the settings interface.

The reference information interface may allow users to add and/or modify references used in questions to assist the auditor in answering the question. References may be attached with a question while creating a template. As discussed above, when a reference is attached to a question, user device 110 may provide access to the reference when the user addresses the question.

The user management interface may provide functionality to create/manage new users and assign corresponding user permissions (e.g., corporate administrator, manager, BSP, etc.). For example, a user with “corporate administrator” permission may have access to everything, while a user with only “BSP” permission may not have access to administration-related functions. A user with “manager” permission may have access to administration-related functions but cannot edit reviews.

In some embodiments, the password settings interface may include settings related to password expiration and reuse when changing a password and/or functionality allowing a user to reset all user password.

The email template settings interface may provide control over emails which are sent out on certain events like new user creation, reset password, review notifications, etc. A franchisor may change email contents according to their needs by using this interface.

At step 706, server 120 may provide a template management interface allowing the user to create and/or manage (e.g., rename, share, delete, etc.) templates for use in self reviews. Templates may include categories and questions used in a self-review process 200 as described above.

FIG. 7B shows a detailed flow diagram of a scoring option during the template management step 706. The user may either choose to create new self-review/reviewer template at step 7061, or choose to edit self-review/reviewer template at step 7062. The user is then directed to the scoring option at step 7063. The user may choose whether or not to enable this option at step 7064. If this option is disabled, the passing score requirement will be disabled at step 7065. If this option is enabled, the user may provide a passing score at step 7066 and assign individual scores and weights to each category/question at step 7067.

FIG. 7C is a detailed flow diagram of a multiple self-review templates option during the template management step 706. Server 120 may provide a self-review template list at step 707 and require the user's input on whether or not to allow multiple self-review templates at step 7071. If this option is enabled, NEW SELF-REVIEW TEMPLATE button is available at step 7072. If this option is disabled, NEW SELF-REFEW TEMPLATE button is not available and the user may only edit existing self-review template at step 7073.

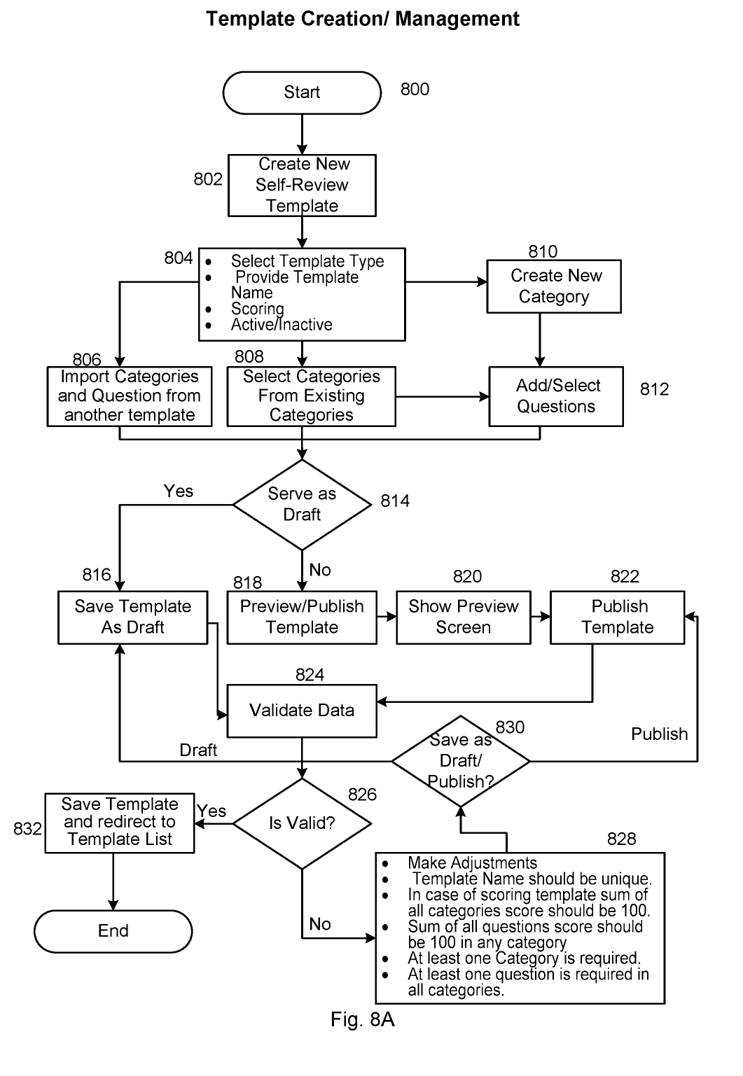

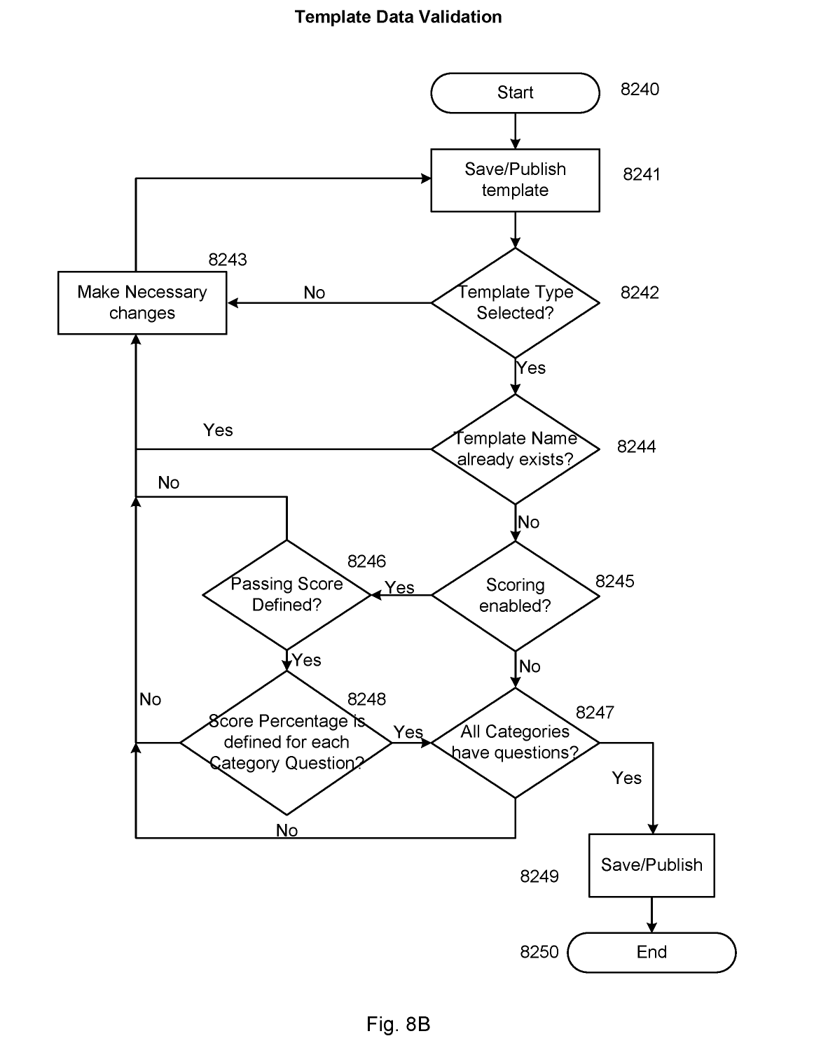

At step 708, server 120 may create a new self-review template. At step 710, server 120 may add categories and questions to the template. At step 712, server 120 may publish the template. This process is illustrated in greater detail in FIG. 8.

FIG. 8A is a template creation process 800 according to some embodiments of the disclosure. Server 120 may perform template management process 800 when a user instructs server 120 to create a new template with the template management interface.

At step 802, server 120 may receive user input to create a new template for a review. At step 804, server 120 may receive user input of a selected review template type, template name, scoring, and/or whether the template is to be active or inactive. When a template is set to be inactive, it may not show up on the list of reviews on the front end. When setting up the system for the first time, a corporate administrator may create categories at step 810. For example, for restaurants, there may be two categories under a tab: front of house and back of house. When a corporate user creates a review, two options may be available. The user may import entire categories and questions from another review template as shown in step 806, which saves the time to re-enter everything. Alternatively, the user may select categories from existing categories as shown in step 808. At step 812, server 120 may receive user selection of questions and/or newly created questions for the template. At step 814, server 120 may ask the user if the template needs to be saved as a draft and receive a response from the user.

At step 816, server 120 may save the template as a draft, for example in response to user command at step 814 or automatically on a periodic basis. At step 818, in response to a user command (e.g., a command indicating template is not to be saved as a draft at step 814), server 120 may enter a preview/publish template mode. At step 820, server 120 may cause a preview of the template to be displayed. If the user is satisfied with the preview, the user may instruct server 120 to publish the template. At step 822, in response to user input, server 120 may publish the template.

At step 824, after the template is saved as a draft or published, server 120 may analyze the validity of the template data. The detailed data validation process is shown in FIG. 8B. The process starts at step 8240. After server 120 save or publish the template at step 8241, server 120 may determine if any valid template type is selected at step 8242. If not, server 120 may display an error at the user interface and require the user to make necessary changes at step 8243. If a valid template type is selected, server 120 may then proceed to step 8244 where it may determine whether the inputted template name already exists. If yes, it may display an error at the user interface and require the user to make changes at step 8243. If the template name has never been used, server 120 may then proceed to step 8245 where it may determine if scoring is enabled for this template. If yes, server 120 may then determine if a passing score is defined at step 8246. Server 120 may then determine if a score percentage is defined for each category/question at step 8248. Server 120 may require the user to make changes if either a pass score or a score percentage is not defined. Alternatively, scoring may be disabled for the template. In the next step, server 120 may check whether all categories have questions. If yes, server 120 may validate the template data and may save or publish the validated template data at step 8249. If not, server 120 may require the user to make changes. The template data validation process ends at step 8250.

At step 826, server 120 may determine whether the data is valid as a result of the analysis. If the data is not valid, at step 828, server 120 may automatically make adjustments to the data to make it valid and/or may request and receive user edits to the data to make it valid. For example, the template may require a new unique name, scoring may need to be adjusted to add up to 100 across all categories, question scores in a category may need to be adjusted to add up to 100, a category may be required to be added, a question may be required for all categories, etc. Once corrections are made, at step 830, server 120 may save the template as a draft or publish the template to complete the operation of step 816 or step 822. If the template is valid, at step 832, server 120 may save the template and return the user interface to a template list display.

Returning to FIG. 7A, at step 714, server 120 may provide a general settings interface. The interface may allow a user to adjust settings related to franchisor's company information. company's address, email, and integration settings with the user device 110 self-review application, for example. The interface may include reviewer settings related to auditor/BSP such as location tracking, reviewer title, considered on location settings, critical failure settings, etc. The interface may include review settings such as review approval settings, self-review settings, review notification settings, follow-up reminders, daily pin, etc.

At step 716, server 120 may provide a more detailed self-review setting interface. The interface may comprise multiple settings. In some embodiments, the interface may require user's selection regarding whether or not to auto approve resolved action items, as shown in step 718. If this “auto approve” feature is enabled, resolved action items may be automatically be approved after a pre-determined number of days at step 722. If this feature is disabled, resolved action items may only be approved manually at step 720. In some embodiments, the self-review setting interface may require user's selection regarding whether or not to include self-review in review stats, as shown in step 724. At step 726, if this feature is enabled, the stats (e.g., Submitted Reviews, Pending Reviews, Follow-ups, etc.) may be shown from Self-Reviews in dashboard left panel so that franchisees have access to them. If this feature is disabled, the stats (e.g., Submitted Reviews, Pending Reviews, Follow-ups, etc.) may only be shown from Corporate-Reviews in dashboard left panel, thus only the corporate administrators have access to them. In some embodiments, the self-review setting may require user's input regarding whether or not to allow multiple templates as shown in step 730. If this feature is enabled, multiple templates may be created for self-reviews at step 732. If this feature is disabled, multiple templates cannot be created for self-reviews at step 734.

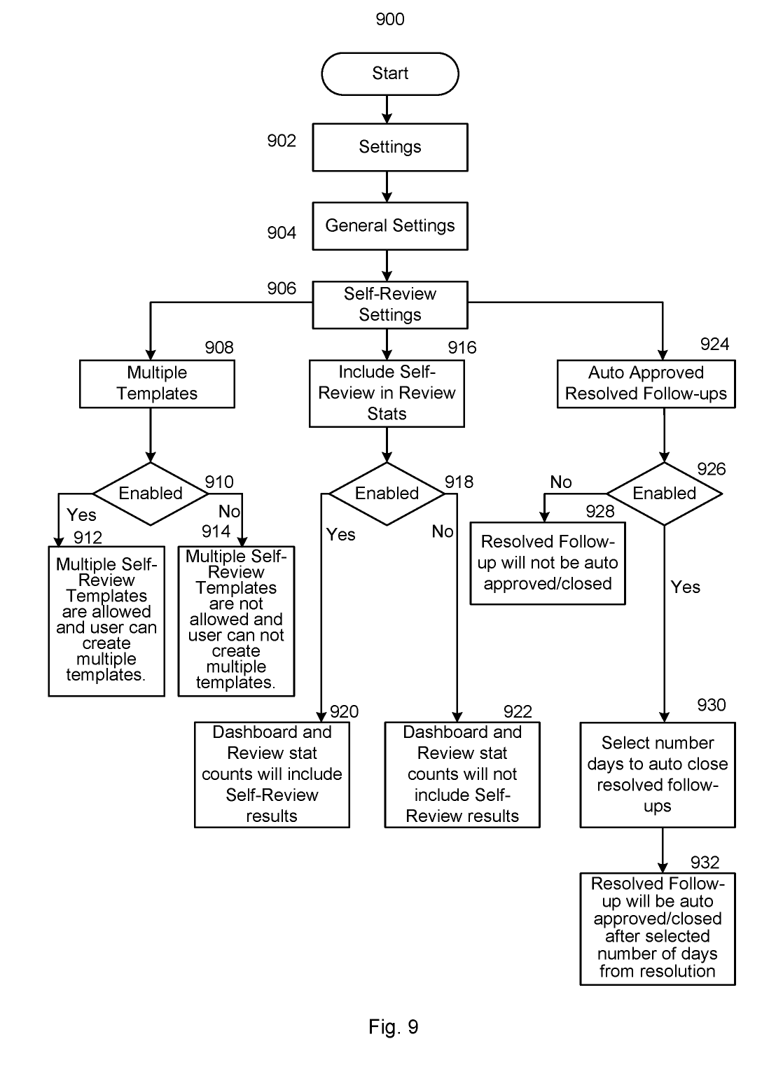

FIG. 9 is a review settings process 900 for franchisees according to some embodiments of the disclosure. Different from the admin process 700, the review setting process 900 may not include the module that create new templates. Server 120 may provide settings 902, general settings 904, and self-review settings 906 which may further require user's input on whether to include multiple template 908s. If this feature is enabled at step 910, multiple self-review templates may be allowed at step 912. If this feature is disabled, multiple self-review templates are not allowed and user may be prevented from creating multiple templates at step 914. In some embodiments, the self-review settings may require user's input on whether or not to include self-review in review stats at step 916. The user may either enable or disable this feature at step 918. Dashboard and Review stat counts may either include (step 920) or not include (step 922) self-review results according to user's selection. In some embodiments, the self-review settings may require user's input on whether to auto approve resolved follow-ups at step 924. If the user does not this feature at step 926, resolved follow-up may not be auto approved/closed at step 928. If this feature is enabled, the user may select a threshold value for the number of days at 930, and resolved follow-up may be auto approved/closed after the selected number of days at step 932.

The corporate team may go through all self-reviews completed by all franchise locations to ensure accuracy and review flagged items. Follow-ups added while performing review from user device may be visible to corporate users with tags/flags, so that corporate users may be aware of follow-up items included in a review. In some embodiments, follow-ups may include information related to the problem in text form and pictures or videos. Corporate users may approve or reject any follow-ups based on provided resolutions and/or evidences.

### Example System Architecture

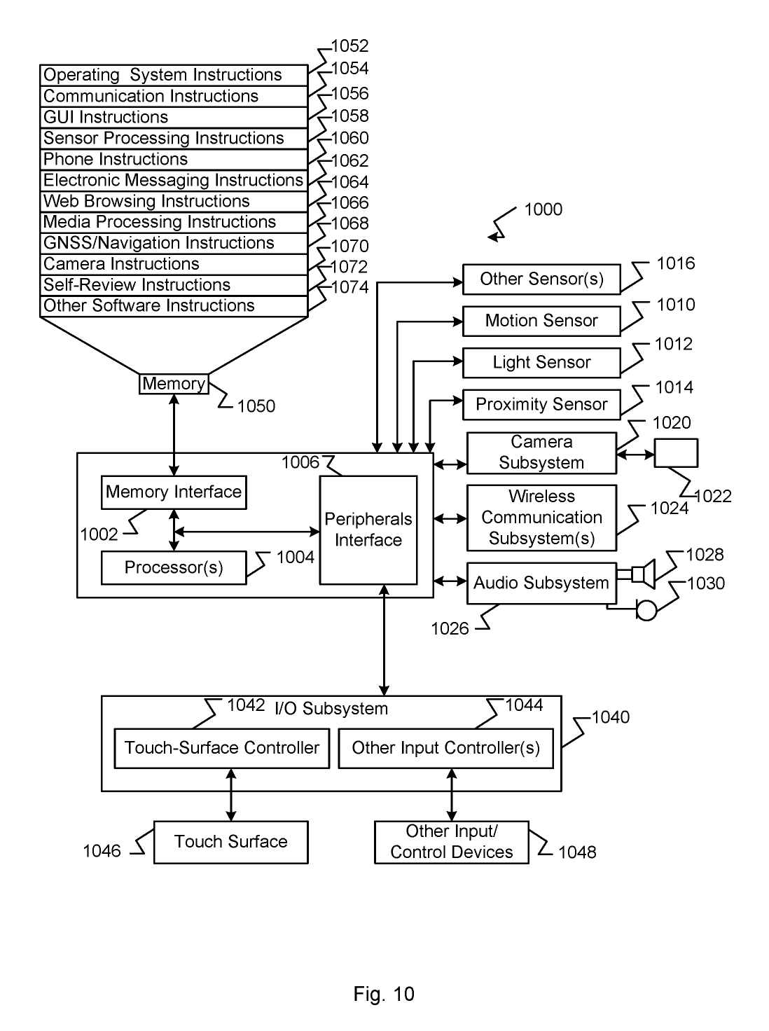

FIG. 10 is a block diagram of an example computing device 1000 that may implement the features and processes of FIGS. 1-9. The computing device 1000 may include a memory interface 1002, one or more data processors, image processors, and/or central processing units 1004, and a peripherals interface 1006. The memory interface 1002, the one or more processors 1004, and/or the peripherals interface 1006 may be separate components or may be integrated in one or more integrated circuits. The various components in the computing device 1000 may be coupled by one or more communication buses or signal lines.

Sensors, devices, and subsystems may be coupled to the peripherals interface 1006 to facilitate multiple functionalities. For example, a motion sensor 1010, a light sensor 1012, and a proximity sensor 1014 may be coupled to the peripherals interface 1006 to facilitate orientation, lighting, and proximity functions. Other sensors 1016 may also be connected to the peripherals interface 1006, such as a global navigation satellite system (GNSS) (e.g., GPS receiver), a temperature sensor, a biometric sensor, magnetometer or other sensing device, to facilitate related functionalities.

A camera subsystem 1020 and an optical sensor 1022, e.g., a charged coupled device (CCD) or a complementary metal-oxide semiconductor (CMOS) optical sensor, may be utilized to facilitate camera functions, such as recording photographs and video clips. The camera subsystem 1020 and the optical sensor 1022 may be used to collect images of a user to be used during authentication of a user, e.g., by performing facial recognition analysis.

Communication functions may be facilitated through one or more wireless communication subsystems 1024, which may include radio frequency receivers and transmitters and/or optical (e.g., infrared) receivers and transmitters. The specific design and implementation of the communication subsystem 1024 may depend on the communication network(s) over which the computing device 1000 is intended to operate. For example, the computing device 1000 may include communication subsystems 1024 designed to operate over a GSM network, a GPRS network, an EDGE network, a Wi-Fi or WiMAX network, and a Bluetooth™ network. In particular, the wireless communication subsystems 1024 may include hosting protocols such that the device 1000 may be configured as a base station for other wireless devices.

An audio subsystem 1026 may be coupled to a speaker 1028 and a microphone 1030 to facilitate voice-enabled functions, such as speaker recognition, voice replication, digital recording, and telephony functions. The audio subsystem 1026 may be configured to facilitate processing voice commands, voice printing and voice authentication, for example.

The I/O subsystem 1040 may include a touch-surface controller 1042 and/or other input controller(s) 1044. The touch-surface controller 1042 may be coupled to a touch surface 1046. The touch surface 1046 and touch-surface controller 1042 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1046.

The other input controller(s) 1044 may be coupled to other input/control devices 1048, such as one or more buttons, rocker switches, thumb-wheel, infrared port, USB port, and/or a pointer device such as a stylus. The one or more buttons (not shown) may include an up/down button for volume control of the speaker 1028 and/or the microphone 1030.

In some implementations, a pressing of the button for a first duration may disengage a lock of the touch surface 1046; and a pressing of the button for a second duration that is longer than the first duration may turn power to the computing device 1000 on or off. Pressing the button for a third duration may activate a voice control, or voice command, module that enables the user to speak commands into the microphone 1030 to cause the device to execute the spoken command. The user may customize a functionality of one or more of the buttons. The touch surface 1046 can, for example, also be used to implement virtual or soft buttons and/or a keyboard.

In some implementations, the computing device 1000 may present recorded audio and/or video files, such as MP3, AAC, and MPEG files. In some implementations, the computing device 1000 may include the functionality of an MP3 player, such as an iPod™. The computing device 1000 can, therefore, include a 76-pin connector that is compatible with the iPod. Other input/output and control devices may also be used.

The memory interface 1002 may be coupled to memory 1050. The memory 1050 may include high-speed random access memory and/or non-volatile memory, such as one or more magnetic disk storage devices, one or more optical storage devices, and/or flash memory (e.g., NAND, NOR). The memory 1050 may store an operating system 1052, such as Darwin, RTXC, LINUX, UNIX, OS X, WINDOWS, or an embedded operating system such as VxWorks.

The operating system 1052 may include instructions for handling basic system services and for performing hardware dependent tasks. In some implementations, the operating system 1052 may be a kernel (e.g., UNIX kernel). In some implementations, the operating system 1052 may include instructions for performing voice authentication. For example, operating system 1052 may implement some or all of the self-review features as described with reference to FIGS. 1-9, alone or in combination with other instructions.

The memory 1050 may also store communication instructions 1054 to facilitate communicating with one or more additional devices, one or more computers and/or one or more servers. The memory 1050 may include graphical user interface instructions 1056 to facilitate graphic user interface processing; sensor processing instructions 1058 to facilitate sensor-related processing and functions; phone instructions 1060 to facilitate phone-related processes and functions; electronic messaging instructions 1062 to facilitate electronic-messaging related processes and functions; web browsing instructions 1064 to facilitate web browsing-related processes and functions; media processing instructions 1066 to facilitate media processing-related processes and functions; GNSS/Navigation instructions 1068 to facilitate GNSS and navigation-related processes and instructions; and/or camera instructions 1070 to facilitate camera-related processes and functions.

The memory 1050 may store self-review instructions 1072 to facilitate other processes and functions, such as the self-review processes and functions as described with reference to FIGS. 1-9. The memory 1050 may also store other software instructions 1074, such as web video instructions to facilitate web video-related processes and functions; and/or web shopping instructions to facilitate web shopping-related processes and functions. In some implementations, the media processing instructions 1066 are divided into audio processing instructions and video processing instructions to facilitate audio processing-related processes and functions and video processing-related processes and functions, respectively.

Each of the above identified instructions and applications may correspond to a set of instructions for performing one or more functions described above. These instructions need not be implemented as separate software programs, procedures, or modules. The memory 1050 may include additional instructions or fewer instructions. Furthermore, various functions of the computing device 1000 may be implemented in hardware and/or in software, including in one or more signal processing and/or application specific integrated circuits.

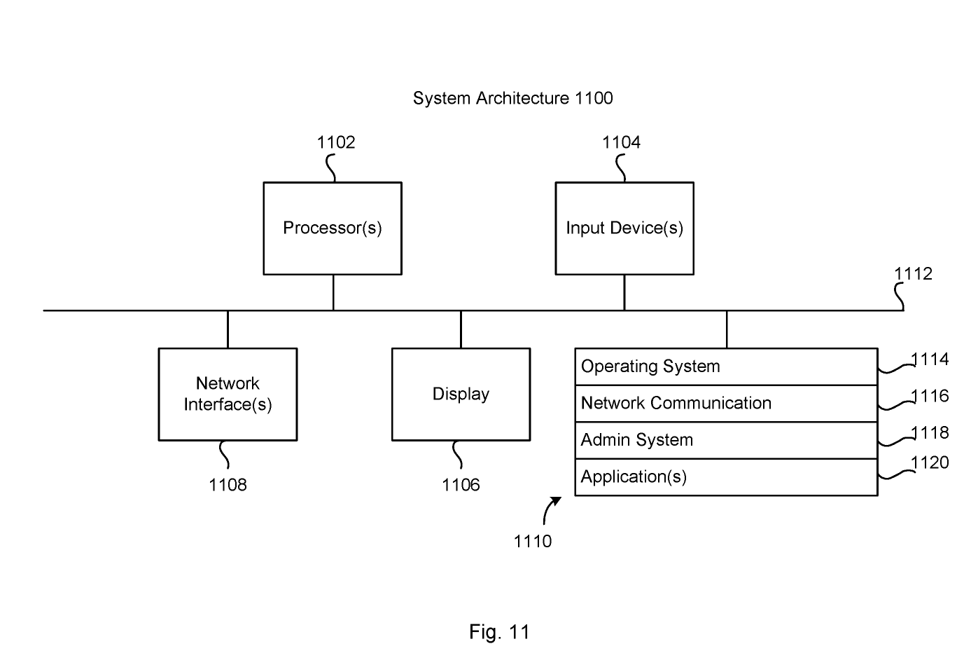

FIG. 11 is a block diagram of an example system architecture implementing the features and processes of FIGS. 1-9. The architecture 1100 may be implemented on any electronic device that runs software applications derived from compiled instructions, including without limitation personal computers, servers, smart phones, media players, electronic tablets, game consoles, email devices, etc. In some implementations, the architecture 1100 may include one or more processors 1102, one or more input devices 1104, one or more display devices 1106, one or more network interfaces 1108, and one or more computer-readable mediums 1110. Each of these components may be coupled by bus 1112.

Display device 1106 may be any known display technology, including but not limited to display devices using Liquid Crystal Display (LCD) or Light Emitting Diode (LED) technology. Processor(s) 1102 may use any known processor technology, including but not limited to graphics processors and multi-core processors. Input device 1104 may be any known input device technology, including but not limited to a keyboard (including a virtual keyboard), mouse, track ball, and touch-sensitive pad or display. Bus 1112 may be any known internal or external bus technology, including but not limited to ISA, EISA, PCI, PCI Express, NuBus, USB, Serial ATA or FireWire. Computer-readable medium 1110 may be any medium that participates in providing instructions to processor(s) 1102 for execution, including without limitation, non-volatile storage media (e.g., optical disks, magnetic disks, flash drives, etc.), or volatile media (e.g., SDRAM, ROM, etc.).

Computer-readable medium 1110 may include various instructions 1114 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 1104; sending output to display device 1106; keeping track of files and directories on computer-readable medium 1110; controlling peripheral devices (e.g., disk drives, printers, etc.) which may be controlled directly or through an I/O controller; and managing traffic on bus 1112. Network communications instructions 1116 may establish and maintain network connections (e.g., software for implementing communication protocols, such as TCP/IP, HTTP, Ethernet, etc.).

An admin system 1118 may include instructions that may generate and provide admin interfaces and tools that use or implement the processes described in reference to FIGS. 1-9. Application(s) 1120 may be an application that uses or implements the processes described in reference to FIGS. 1-9. The processes may also be implemented in operating system 1114.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of auditing a franchise site with a user device, the method comprising:
generating, by a location module of the user device, location data for the user device;
determining, by a processor circuit of the user device in communication with the location module, from the location data whether the user device is at the franchise site or a different location;
generating, by a camera module of the user device in communication with the processor circuit, image data;
comparing, by the processor circuit, the image data with known image data for a specified portion of the franchise site to determine whether the image data includes an image of the specified portion of the franchise site or a different image; and
in response to determining that the user device is at the franchise site and determining that the image data includes the image of the specified portion of the franchise site, sending, by a communication module of the user device in communication with the processor circuit, at least a portion of the location data, at least a portion of the image data, or a combination thereof to a server.

2. The method of claim 1, wherein the location module comprises a GPS transponder, a cellular transponder, a Wi-Fi transponder, or a combination thereof.

3. The method of claim 1, wherein the determining whether the user device is at the franchise site or another location comprises:
sending, by the communication module, the location data to the server; and
receiving, by the communication module, a location comparison result from the server.

4. The method of claim 1, further comprising:
adding, by the processor circuit, a label to the image data.

5. The method of claim 4, wherein the label comprises a time stamp, a location stamp, an IP address, a user's name, an electronic signature, or a combination thereof.

6. The method of claim 1, wherein the image data comprises at least one still image, at least one video, or a combination thereof.

7. The method of claim 1, further comprising:
in response to determining that the user device is at the different location or determining that the image data includes the different image, generating, by the processor, an error message.

8. The method of claim 1, further comprising:
in response to determining that the user device is at the different location or determining that the image data includes the different image, rejecting, by the processor, the image data.

9. The method of claim 1, further comprising:
receiving, by the processor circuit, a personal identification number (PIN) to verify an identity of a user.

10. The method of claim 1, further comprising:
presenting, by the processor circuit, at least one question on a display of the user device in communication with the processor circuit;
receiving, by an input device of the user device in communication with the processor circuit, at least one answer to the at least one question; and
in response to determining that the user device is at the franchise site and determining that the image data includes the image of the specified portion of the franchise site, sending, by the communication module, the at least one answer to the server.

11. A user device configured to audit a franchise site comprising:
a location module configured to generate location data for the user device;
a camera module configured to generate image data;
a communication module; and
a processor circuit in communication with the location module, the camera module, and the communication module, the processor circuit configured to:
determine from the location data whether the user device is at the franchise site or a different location;
compare the image data with known image data for a specified portion of the franchise site to determine whether the image data includes an image of the specified portion of the franchise site or a different image; and
in response to determining that the user device is at the franchise site and determining that the image data includes the image of the specified portion of the franchise site, send, by the communication module, at least a portion of the location data, at least a portion of the image data, or a combination thereof to a server.

12. The user device of claim 11, wherein the location module comprises a GPS transponder, a cellular transponder, a Wi-Fi transponder, or a combination thereof.

13. The user device of claim 11, wherein the processor circuit is configured to determine whether the user device is at the franchise site or another location by a process comprising:
sending, by the communication module, the location data to the server; and
receiving, by the communication module, a location comparison result from the server.

14. The user device of claim 11, wherein the processor circuit is further configured to add a label to the image data.

15. The user device of claim 14, wherein the label comprises a time stamp, a location stamp, an IP address, a user's name, an electronic signature, or a combination thereof.

16. The user device of claim 11, wherein the image data comprises at least one still image, at least one video, or a combination thereof.

17. The user device of claim 11, wherein the processor circuit is further configured to:
in response to determining that the user device is at the different location or determining that the image data includes the different image, send an error message.

18. The user device of claim 11, wherein the processor circuit is further configured to:
in response to determining that the user device is at the different location or determining that the image data includes the different image, reject the image data.

19. The user device of claim 11, wherein the processor circuit is further configured to:
receive a personal identification number (PIN) to verify an identity of a user.

20. The user device of claim 11, further comprising:
a display; and
an input device;
wherein the processor circuit is further configured to:
present at least one question on the display;
receive, by the input device, at least one answer to the at least one question; and
in response to determining that the user device is at the franchise site and determining that the image data includes the image of the specified portion of the franchise site, send, by the communication module, the at least one answer to the server.
